(19) United States
(12) Patent Application Publication
(10) Pub. No.: US 2024/0208549 A1
(43) Pub. Date: Jun. 27, 2024

(54) INFORMATION PROCESSING APPARATUS AND METHOD

(71) Applicants: TOYOTA JIDOSHA KABUSHIKI KAISHA, Aichi-ken (JP); NIPPON TELEGRAPH AND TELEPHONE CORPORATION, Tokyo (JP)

(72) Inventors: Ko KOGA, Tokyo-to (JP); Toshifumi NISHIJIMA, Kasugai-shi (JP); Hiroaki SUGIYAMA, Tokyo-to (JP)

(21) Appl. No.: 18/396,635

(22) Filed: Dec. 26, 2023

(30) Foreign Application Priority Data
Dec. 27, 2022 (JP) 2022-210177

(51) Int. Cl. B60W 60/00; B60W 50/14; G06V 20/58

(52) U.S. Cl. CPC B60W 60/0053; B60W 50/14; G06V 20/58; B60W 2420/403; B60W 2540/00; B60W 2540/21; B60W 2552/05

(57) ABSTRACT

An information processing apparatus includes a processor configured to: determine a first timing that precedes a notification for announcing in advance switching from autonomous driving of a vehicle to manned driving, in a case where occurrence of the switching from autonomous driving to manned driving is predicted due to the vehicle capable of autonomous driving approaching a predetermined location, and output to the vehicle, in a case where the first timing is reached, utterance content that takes, as a topic, an object that is present in front of the vehicle, the object being detected from a captured image from a vehicle-mounted camera of the vehicle.

### CROSS REFERENCE TO THE RELATED APPLICATION

This application claims the benefit of Japanese Patent Application No. 2022-210177, filed on Dec. 27, 2022, which is hereby incorporated by reference herein in its entirety.

### BACKGROUND

### Technical Field

The present disclosure relates to a machine that has a conversation with a person.

### Description of the Related Art

There is disclosed a notification control apparatus that urges a driver to take over driving when occurrence of a driving takeover event that requires switching from an autonomous driving mode to a manned driving mode is detected (for example, Patent Document 1).
[Patent Document 1] Japanese Patent Laid-Open No. 2021-196938
[Non-Patent Document 1] Hiroaki Sugiyama, Ko Koga, Toshifumi Nishijima, “Conversational system that talks about the scenery seen from vehicles”, [online], June 2022, The Japanese Society for Artificial Intelligence, The 36th Annual Conference of the Japanese Society for Artificial Intelligence, 2022, [retrieved Oct. 27, 2022], Internet <URL:https://www.jstage.jst.go.jp/article/pjsai/JSAI2022/0/JSAI2022_2N5OS7a04/_article/-char/ja/>

An aspect of the disclosure is aimed at providing an information processing apparatus and a method that are capable of causing an onboard person to spontaneously pay attention to a front area of a vehicle before an advance notice of occurrence of switching from autonomous driving of the vehicle to manned driving.

### SUMMARY

An aspect of the present disclosure is an information processing apparatus comprising a processor configured to:
determine a first timing that precedes a notification for announcing in advance switching from autonomous driving of a moving object to manned driving, in a case where occurrence of the switching is predicted due to the moving object capable of autonomous driving approaching a predetermined location, and
output to the moving object, in a case where the first timing is reached, utterance content that takes, as a topic, an object that is present in front of the moving object, the object being detected from a captured image from an on-board camera of the moving object.

Another aspect of the present disclosure is a method executed by a computer, comprising:
determining a first timing that precedes a notification for announcing in advance switching from autonomous driving of a moving object to manned driving, in a case where occurrence of the switching is predicted due to the moving object capable of autonomous driving approaching a predetermined location, and
outputting to the moving object, in a case where the first timing is reached, utterance content that takes, as a topic, an object that is present in front of the moving object, the object being detected from a captured image from an on-board camera of the moving object.

According to an aspect of the present disclosure, an onboard person may be made to spontaneously pay attention to a front area of a vehicle before an advance notice of occurrence of switching from autonomous driving of the vehicle to manned driving.

### BRIEF DESCRIPTION OF THE DRAWINGS

FIG. 1 is a diagram according to a first embodiment, illustrating an example of a system configuration of a conversational system;

FIG. 2 is a diagram illustrating an example of hardware configurations of the server and the vehicle;

FIG. 3 is a diagram illustrating an example of a functional configuration of the server;

FIG. 4 is an example of a flowchart of a mode transition process by the line-of-sight guidance control unit;

FIG. 5 is an example of a flowchart of an impression utterance generation process by the impression utterance system; and

FIG. 6 is an example of a flowchart of an utterance determination process by the utterance determination unit.

### DESCRIPTION OF THE EMBODIMENTS

In relation to a vehicle that is capable of autonomous driving, switching from autonomous driving to manned driving is referred to as takeover. An onboard person is notified in advance of occurrence of takeover due to a takeover request. However, a time from the takeover request until takeover is about three seconds, for example, and is possibly not enough for a driver to easily cope with such a situation.

An aspect of the present disclosure, to solve such a problem, presents an utterance about an object that is present in front of a vehicle to an onboard person at a timing preceding the takeover request to guide a line of sight of the onboard person to a front area of the vehicle, and the onboard person may thus prepare for the takeover request. More specifically, an aspect of the present disclosure is an information processing apparatus including a processor. The processor may be configured to determine a first timing that precedes a notification for announcing in advance switching from autonomous driving of a vehicle to manned driving, in a case where occurrence of the switching is predicted due to the vehicle capable of autonomous driving approaching a predetermined location. The processor may be configured to output to the vehicle, in a case where the first timing is reached, utterance content that takes, as a topic, an object that is present in front of the vehicle, the object being detected from a captured image from an on-board camera of the vehicle.

For example, the information processing apparatus is a dedicated computer such as a server. In the case where the information processing apparatus is a server, the processor is a processor such as a central processing unit (CPU) or a digital signal processor (DSP) that is provided in the server, for example. Alternatively, the information processing apparatus may be a data communication apparatus that is mounted on a vehicle, a car navigation system, a dashboard camera, or a dedicated on-board apparatus such as an electronic control unit (ECU), for example. In the case where the information processing apparatus is an on-board apparatus, the processor is a processor such as a CPU or a DSP that is provided in the on-board apparatus, for example.

In the case where the information processing apparatus is a server, the processor may transmit, to the vehicle, as one output, the utterance content that takes, as a topic, an object that is present in front of the vehicle. In the case where the information processing apparatus is a vehicle-mounted apparatus, the processor may output, from a speaker, in a form of sound, the utterance content that takes, as a topic, an object that is present in front of the vehicle. The predetermined location as a cause of occurrence of switching from autonomous driving to manned driving may be an intersection, a multi-forked road, an interchange, or a junction, for example. The notification for announcing in advance switching from autonomous driving to manned driving is the takeover request, for example.

According to an aspect of the present disclosure, when the first timing that precedes the notification about switching from autonomous driving to manned driving is reached, attention of an onboard person in the vehicle is guided naturally to the front area of the vehicle by an utterance that takes, as a topic, an object that is present in front of the vehicle. Accordingly, the onboard person is already facing front when the notification about switching from autonomous driving to manned driving occurs later, and the onboard person may easily cope with switching from autonomous driving to manned driving.

In an aspect of the present disclosure, the processor may be configured to generate first utterance content that results from an utterance from an onboard person in the vehicle, and generate second utterance content that takes, as a topic, an object detected from the captured image from the vehicle-mounted camera. The processor may determine utterance content to be output, from the first utterance content and the second utterance content. In the case where the first timing is reached, the processor may prioritize the second utterance content over the first utterance content, and determine the second utterance content that takes, as the topic, the object that is present in front of the vehicle to be the utterance content to be output.

Accordingly, for example, in a case where the first timing is reached while a conversation is being held between the onboard person and the information processing apparatus, the second utterance content that takes, as the topic, an object that is present in front of the vehicle is output to the vehicle by being prioritized over the first utterance content that is based on an utterance from the onboard person. For example, when a conversation is being held between the onboard person and the information processing apparatus, the onboard person is possibly not facing front. Therefore, according to an aspect of the present disclosure, attention of the onboard person may be more reliably and naturally guided to the front area of the vehicle when the first timing is reached.

In the following, embodiments of the present disclosure will be described with reference to the drawings. The configuration of the embodiments described below are examples, and the present disclosure is not limited to the configuration of the embodiments.

### First Embodiment

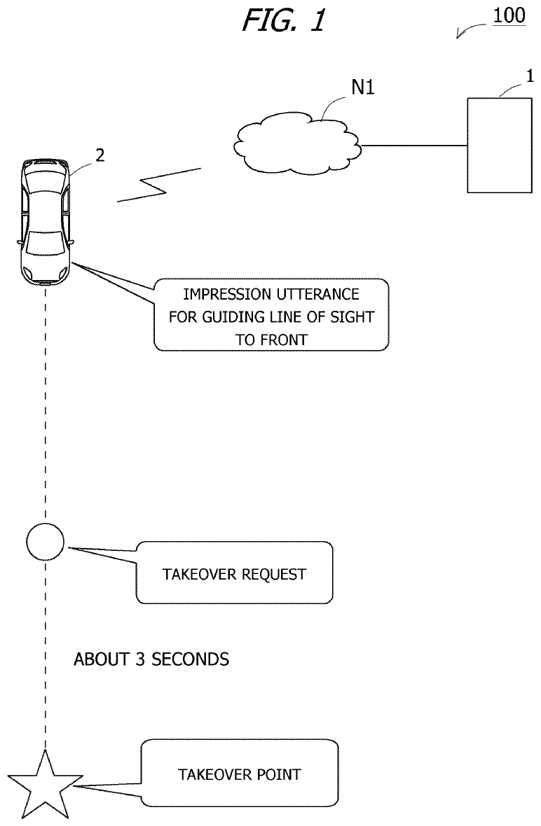

FIG. 1 is a diagram according to a first embodiment, illustrating an example of a system configuration of a conversational system 100. The conversational system 100 is a system that provides a conversation service for an onboard person in a vehicle. The conversational system 100 includes a server 1 and a vehicle 2. The server 1 and the vehicle 2 are each connected to a network N1, and are capable of communicating with each other over the network N1. The network N1 is a public network such as the Internet, for example.

The vehicle 2 is a so-called connected vehicle provided with a vehicle-mounted apparatus including a communication function. Furthermore, in the first embodiment, the vehicle 2 is a vehicle that is capable of autonomous driving at about autonomous driving level 3 or 4. The vehicle 2 is assumed to be a vehicle that travels while switching between autonomous driving and manned driving that is based on operation by a driver.

The vehicle 2 transmits, to the server 1 via the vehicle-mounted apparatus, a captured image from a camera that is installed facing outside the vehicle every predetermined period of time. Furthermore, the vehicle 2 transmits, to the server 1 via the vehicle-mounted apparatus, audio data of voice that is uttered by the onboard person in the vehicle and that is collected by a microphone.

The server 1 generates utterance content based on each of the captured image from the camera and the audio data of utterance that are received from the vehicle 2. The utterance content generated from the captured image will be referred to below as impression utterance. The utterance content generated from the utterance of the onboard person will be referred to below as context utterance. The server 1 selects the utterance content to be output, from the impression utterance and the context utterance, and transmits the same to the vehicle 2. In the following, the utterance content output from the server 1 will be referred to as system utterance. The vehicle 2 outputs the system utterance received from the server 1, from the microphone. By repeating the process, a conversation is held between the onboard person and the conversational system 100. The context utterance is an example of “first utterance content”. The impression utterance is an example of “second utterance content”.

In the first embodiment, in the case where the vehicle 2 is approaching a takeover point, the server 1 determines a timing that precedes occurrence of the takeover request as a mode transition timing. The takeover point is a location where traveling is specified to be performed by manned driving. For example, the takeover point is an intersection, an interchange, or a junction. The mode transition timing is a timing of transition to a line-of-sight guidance mode for guiding a line of sight of the onboard person to a front area of the vehicle. In the case where the mode transition timing is reached, the server 1 transitions to the line-of-sight guidance mode. After transitioning to the line-of-sight guidance mode, the server 1 prioritizes the impression utterance over the context utterance, and outputs the impression utterance as the system utterance. Furthermore, in the line-of-sight guidance mode, the server 1 sets a high degree of priority to an impression utterance that takes, as a topic, an object that is present in front of the vehicle such that the impression utterance is likely to be output as the system utterance.

That is, the server 1 transitions to the line-of-sight guidance mode at a timing that precedes occurrence of the takeover request, and transmits, to the vehicle 2, the impression utterance that takes, as the topic, an object that is present in front of the vehicle. When the impression utterance is output, the onboard person in the vehicle 2 is made to pay attention to the front area of the vehicle, and may easily cope with the situation when the takeover request is issued at a later timing. The mode transition timing is an example of “first timing”. The takeover point is an example of “predetermined location”.

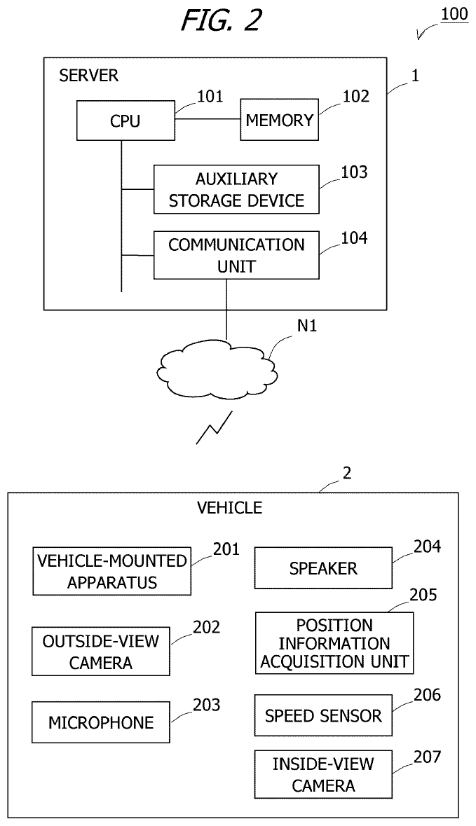

FIG. 2 is a diagram illustrating an example of hardware configurations of the server 1 and the vehicle 2. As hardware components, the server 1 includes a CPU 101, a memory 102, an auxiliary storage device 103, and a communication unit 104. The memory 102 and the auxiliary storage device 103 are each an example of a computer-readable recording medium.

The auxiliary storage device 103 stores various programs, and data to be used by the CPU 101 at the time of execution of each program. For example, the auxiliary storage device 103 is a hard disk drive (HDD), a solid state drive (SSD), and the like. Programs to be held in the auxiliary storage device 103 include an operating system (OS), and other programs, for example.

The memory 102 is a main memory that provides a working area and a memory area where programs stored in the auxiliary storage device 103 are loaded, and that is used as a buffer, for example. The memory 102 includes semiconductor memories such as a read only memory (ROM) and a random access memory (RAM), for example.

The CPU 101 performs various processes by loading, into the memory 102, and executing the OS and various other programs held in the auxiliary storage device 103. The number of CPUs 101 is not limited to one, and may be more than one. The CPU 101 is an example of “processor”.

The communication unit 104 is a module connecting to a network cable and including a circuit for signal processing such as a local area network (LAN) card and an optical module a, for example. The communication unit 104 is not limited to a circuit that can be connected to a wired network, and may instead be a wireless signal processing circuit that is capable of processing wireless signals of a wireless communication network such as WiFi. Additionally, the hardware configuration of the server 1 is not limited to the one illustrated in FIG. 2.

Next, the vehicle 2 includes, as hardware components, a vehicle-mounted apparatus 201, an outside-view camera 202, a microphone 203, a speaker 204, a position information acquisition unit 205, a speed sensor 206, and an inside-view camera 207. Additionally, as the hardware components of the vehicle 2, FIG. 2 extracts and illustrates elements related to processing by the conversational system 100. The hardware components are interconnected by a predetermined in-vehicle network or the like.

The outside-view camera 202 is installed on a windshield of the vehicle 2, near a ceiling, in a manner facing outside the vehicle 2 such that a front area of the vehicle 2 is taken as the capturing range, for example. The outside-view camera 202 may be a camera that is installed in a dashboard camera, or may be a camera that is installed for the conversational system 100, for example. A plurality of outside-view cameras 202 may be provided in the vehicle 2. In the case where a plurality of outside-view cameras 202 are provided, the outside-view cameras 202 may include cameras that are installed on left and right wing mirrors.

The microphone 203 and the speaker 204 may be a microphone and a speaker that are installed in a car navigation system or a dashboard camera, for example. Alternatively, the microphone 203 and the speaker 204 may be a microphone and a speaker that are installed for the conversational system 100, for example.

The position information acquisition unit 205 acquires position information of the vehicle 2 every predetermined period of time. The position information acquisition unit 205 is a global positioning system (GPS) receiver, for example. In the first embodiment, the outside-view camera 202 and the inside-view camera 207 each acquire the position information from the position information acquisition unit 205 every predetermined period of time, and attach the same to the captured image as capturing time information.

The speed sensor 206 is a sensor that measures a traveling speed of the vehicle 2. The inside-view camera 207 is a camera that is installed on the windshield of the vehicle 2, near the ceiling, in a manner facing inside the vehicle 2. A state of the onboard person is acquired from a captured image from the inside-view camera 207, for example. The outside-view camera 207 may be a camera that is installed in the dashboard camera, or may be a camera that is installed for the conversational system 100, for example.

For example, the vehicle-mounted apparatus 201 is a data communication apparatus, a car navigation system, a dashboard camera, or an ECU for the conversational system 100. As hardware components, the vehicle-mounted apparatus 201 includes a CPU, a memory, an auxiliary storage device, and a wireless communication unit. The CPU, the memory, and the auxiliary storage device are the same as the CPU 101, the memory 102, and the auxiliary storage device 103. The wireless communication unit of the vehicle-mounted apparatus 201 is a wireless signal processing circuit compatible with any of mobile communication methods such as 5G, 4G, long term evolution (LTE), and 6G, and wireless communication methods such as Wi-Fi, WiMAX, and dedicated short range communications (DSRC), for example.

The vehicle-mounted apparatus 201 acquires a captured image from each of the outside-view camera 202 and the inside-view camera 207 every predetermined period of time, and transmits the same to the server 1. The period of time at which the captured image from each of the outside-view camera 202 and the inside-view camera 207 is transmitted by the vehicle-mounted apparatus 201 may be the same as respective capturing periods of the outside-view camera 202 and the inside-view camera 207, or may be freely set from one second to 10 seconds by an administrator of the conversational system 100 or the onboard person, for example. The capturing periods of the outside-view camera 202 and the inside-view camera 207 take a value from 15 fps to 60 fps, for example. Additionally, a transmission period for the outside-view camera 202 and a transmission period for the inside-view camera 207 may be different from each other.

Moreover, the vehicle-mounted apparatus 201 transmits utterance content from the onboard person collected by the microphone 203 to the server 1. Furthermore, in the case where the system utterance is received from the server 1, the vehicle-mounted apparatus 201 outputs the same from the speaker 204. A data format of the utterance content transmitted and received between the vehicle-mounted apparatus 201 and the server 1 may be audio data or text data, for example.

The vehicle-mounted apparatus 201 transmits, to the server 1, together with the captured image from the outside-view camera 202 or the inside-view camera 207 or the utterance content from the onboard person, an acquisition time, position information indicating an acquisition position, identification information of the vehicle 2, and information about a travel state of the vehicle 2. The information about a travel state of the vehicle 2 is information indicating whether the vehicle is performing autonomous driving or manned driving, and the traveling speed of the vehicle, for example. Additionally, the hardware configuration of the vehicle 2 is merely an example, and is not limited to the hardware configuration illustrated in FIG. 2.

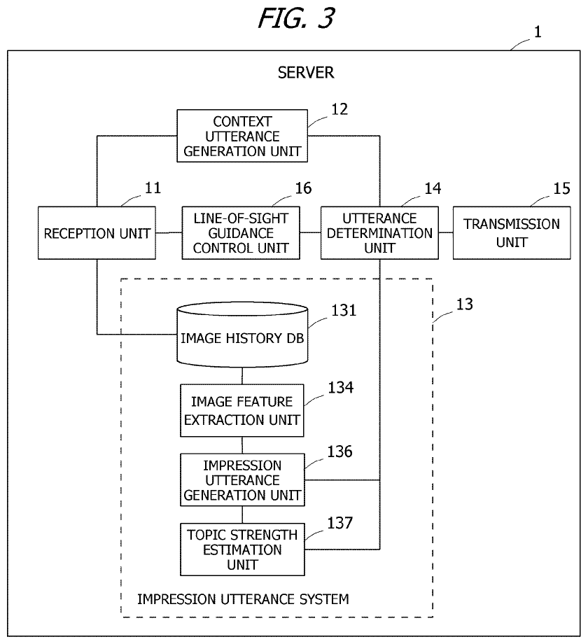

FIG. 3 is a diagram illustrating an example of a functional configuration of the server 1. As functional components, the server 1 includes a reception unit 11, a context utterance generation unit 12, an impression utterance system 13, an utterance determination unit 14, a transmission unit 15, and a line-of-sight guidance control unit 16. Processes by the functional structural elements are implemented through execution of predetermined programs by the CPU 101.

The reception unit 11 receives, from the vehicle 2, the captured image from the outside-view camera 202, the captured image from the inside-view camera 207, and the utterance content from the onboard person. The reception unit 11 stores the captured image from the outside-view camera 202 in an image history DB 131 described later. The reception unit 11 outputs the captured image from the inside-view camera 207 to the line-of-sight guidance control unit 16. The reception unit 11 outputs the utterance content from the onboard person to the context utterance generation unit 12. The acquisition time, the position information indicating the acquisition position, the identification information of the vehicle 2, and information about the travel state of the vehicle 2 are also received from the vehicle 2, together with the captured image from the outside-view camera 202, the captured image from the inside-view camera 207, and the utterance content from the onboard person. Additionally, in the case where the captured image from the outside-view camera 202 is received from the vehicle 2 at a same period as the capturing period of the outside-view camera 202, the reception unit 11 may thin out the captured images received, and may save the captured images from the outside-view camera 202 that are received in the image history DB 131 every one second, for example. Reducing the number of captured images from the outside-view camera 202 that are to be saved in the image history DB 131 allows a processing load on the server 1 to be reduced.

In the case where utterance content from the onboard person is input from the reception unit 11, the context utterance generation unit 12 generates the context utterance based on the utterance content. A method of generating the context utterance by the context utterance generation unit 12 is not limited to a specific method. For example, the context utterance generation unit 12 generates the context utterance by inputting, to a machine learning model, a history of utterance content including the utterance content from the onboard person received, the captured image from the outside-view camera 202, and spot information according to the position information of the captured image. The machine learning model used to generate the context utterance is a Transformer Encoder-decoder model, for example. The context utterance generation unit 12 outputs the context utterance that is generated to the utterance determination unit 14.

The impression utterance system 13 generates the impression utterance from the captured image from the outside-view camera 202 every predetermined period of time. The impression utterance system 13 includes the image history DB 131, an image feature extraction unit 134, an impression utterance generation unit 136, and a topic strength estimation unit 137. For example, the image history DB 131 is generated in a memory area in the auxiliary storage device 103 of the server 1. The image history DB 131 holds the captured image from the outside-view camera 202 received from the vehicle 2, together with a capturing time, position information indicating a capturing position, and information indicating the travel state of the vehicle.

The image feature extraction unit 134 performs, every predetermined period of time, an image analysis process on a latest captured image from the outside-view camera 202 among the captured images stored in the image history DB 131, and detects an object included in the capturing range. A machine learning model such as Deformable-DETR is used for detection of an object from the captured image, for example. However, the machine learning model used for detection of an object from the captured image is not limited to Deformable-DETR. The image feature extraction unit 134 outputs, to the impression utterance generation unit 136, information about an object detected from a detection range in the captured image. A plurality of objects may be detected from the captured image. Information about an object detected from the captured image includes a type of the object, and a position in the captured image, for example. The type of an object may be a building, a mark, a plant, or a person, for example. However, the type of an object that the image feature extraction unit 134 is able to detect is not limited thereto. For example, the image feature extraction unit 134 may also detect the type of an object based on an external color, such as a building with a red roof.

The impression utterance generation unit 136 receives, from the image feature extraction unit 134, input of information about at least one object detected from the captured image from the outside-view camera 202. The impression utterance generation unit 136 acquires spot information in relation to the at least one object, inputs the same to a machine learning model, and acquires at least one impression utterance. The machine learning model used by the impression utterance generation unit 136 is a Transformer Encoder-decoder model, for example. However, the machine learning model that is used by the impression utterance generation unit 136 to generate the impression utterance is not limited thereto. Spot information about an object is information that is obtained by searching through big data such as map information, the Internet, and social network service (SNS) based on the position information, an external appearance of the object, and the like. The impression utterance generation unit 136 outputs the at least one impression utterance that is generated to the topic strength estimation unit 137 and the utterance determination unit 14.

The topic strength estimation unit 137 receives input of the at least one impression utterance from the impression utterance generation unit 136. The topic strength estimation unit 137 estimates strength of each impression utterance. Topic strength of an impression utterance may be said to be a degree of priority of the impression utterance. Strength of an impression utterance is estimated using a machine learning model obtained by learning strength of a topic that is added to a set of an image and an utterance that is learning data for a machine learning model that is used for generation of the impression utterance, for example. The machine learning model used for estimation of topic strength is k-nearest neighbor (kNN), for example. The topic strength estimation unit 137 outputs an estimation result related to the strength of the impression utterance to the utterance determination unit 14.

The utterance determination unit 14 receives input of the context utterance from the context utterance generation unit 12. Furthermore, the utterance determination unit 14 receives input of the impression utterance from the impression utterance system 13. For example, the utterance determination unit 14 determines which of the context utterance or the impression utterance is to be taken as the system utterance, according to a timing of input of the context utterance or the impression utterance. Details of a process by the utterance determination unit 14 will be given later. The utterance determination unit 14 outputs the system utterance to the transmission unit 15. When the system utterance is input from the utterance determination unit 14, the transmission unit 15 transmits the same to the vehicle 2.

The line-of-sight guidance control unit 16 performs prediction of occurrence of takeover in a case where the vehicle 2 is performing autonomous driving. More specifically, the line-of-sight guidance control unit 16 predicts occurrence of takeover by detecting approach when it is a first time length or less until the vehicle 2 arrives at a takeover point according to the position information and speed of the vehicle 2. The first time length may be freely set by the administrator of the conversational system 100 within a range from 30 seconds to three minutes, for example. Additionally, the line-of-sight guidance control unit 16 may predict occurrence of takeover based on a distance to the takeover point, instead of using the first time length. Information about the takeover point may be acquired from map information, for example.

In the case where occurrence of takeover is predicted, the line-of-sight guidance control unit 16 determines the mode transition timing. The line-of-sight guidance control unit 16 sets the mode transition timing to a time point that precedes occurrence of the takeover request. The line-of-sight guidance control unit 16 determines the mode transition timing in such a way that a remaining time until arrival at the takeover point is within a range from five seconds to one minute, for example.

The line-of-sight guidance control unit 16 determines the mode transition timing based on at least one of the state of the onboard person in the vehicle 2, a type of a road where the vehicle 2 is traveling, and a type of the takeover point, for example. The state of the onboard person in the vehicle 2 may be acquired by analyzing the captured image from the inside-view camera 207, for example. In the case where the onboard person is asleep, for example, it is expected that it takes time for the onboard person to wake up and face front. Accordingly, the line-of-sight guidance control unit 16 determines the mode transition timing in such a way that the remaining time until arrival at the takeover point is increased in the manner of the state of the onboard person being asleep>smartphone operation>facing other than front, for example. In the case where the onboard person is already facing front, for example, the line-of-sight guidance control unit 16 may determine not to transition to the line-of-sight guidance mode, and does not have to set the mode transition timing.

For example, types of roads include a local road and a highway. On a highway, one tends to move straight forward over a long distance, and the onboard person tends to become careless. Accordingly, the line-of-sight guidance control unit 16 determines the mode transition timing in such a way that the remaining time until arrival at the takeover point is increased when the type of the road where the vehicle 2 is traveling is a highway than when the type of the road is a local road. The type of the road where the vehicle 2 is traveling may be acquired from the position information of the vehicle 2 and the map information, for example.

For example, the driver has to be more careful the greater the number of branches of a multi-forked road. Accordingly, the line-of-sight guidance control unit 16 determines the mode transition timing in such a way that the remaining time until arrival at the takeover point is increased when the takeover point is a multi-forked road and the number of branches is great.

Additionally, factors for determining the mode transition timing are not limited to those mentioned above. For example, the line-of-sight guidance control unit 16 may determine the mode transition timing based on a surrounding environment of the vehicle 2. A surrounding environment of the vehicle 2 may be traffic congestion, for example. During traffic congestion, the line-of-sight guidance control unit 16 determines the mode transition timing in such a way that the remaining time until arrival at the takeover point is increased.

Additionally, the remaining time until arrival at the takeover point for setting the mode transition timing may be a time that is set in advance in relation to each of the state of the onboard person, the type of the road where the vehicle 2 is traveling, and the number of branches of a multi-forked road. Alternatively, a standard time may be set in advance as the remaining time until arrival at the takeover point for setting the mode transition timing. The line-of-sight guidance control unit 16 may determine the mode transition timing while changing a range of increase/decrease in the standard time according to the state of the onboard person, the type of the road where the vehicle 2 is traveling, the number of branches of a multi-forked road, and the like.

Additionally, degrees of priority may be attached to determination factors for the mode transition timing, such as the state of the onboard person, the type of the road where the vehicle 2 is traveling, and the number of branches of a multi-forked road. In this case, the determination factor having a high degree of priority may be preferentially used. For example, the determination factors for the mode transition timing may be equally treated. In this case, the mode transition timing may be determined by adding, to a determination factor matching the vehicle 2, a range of increase/decrease in the standard time that is set.

In the case where the mode transition timing is reached, the line-of-sight guidance control unit 16 instructs the impression utterance system 13 and the utterance determination unit 14 to transition to the line-of-sight guidance mode. The line-of-sight guidance control unit 16 determines cancelation of the line-of-sight guidance mode in a case where an utterance of the onboard person is detected in relation to output of the impression utterance after transition to the line-of-sight guidance mode and in a case where there is occurrence of a takeover request or a takeover. Additionally, the line-of-sight guidance control unit 16 acquires in advance a timing of occurrence of a takeover request based on a vehicle type of the vehicle 2 or the like, for example, and may estimate occurrence of the takeover request. Alternatively, occurrence of the takeover request may be detected by detecting that information indicating that manned driving is being performed is included in information about traveling of the vehicle 2 that is received from the vehicle 2.

In the case where transition to the line-of-sight guidance mode takes place, the topic strength estimation unit 137 of the impression utterance system 13 sets the topic strength of the impression utterance that takes, as a topic, an object that is present in a predetermined range that is in the captured image from the outside-view camera 202 and to which the line of sight of the onboard person is guided, among the impression utterances generated by the impression utterance generation unit 136, to be higher. The predetermined range to which the line of sight of the onboard person is guided is a range of the line of sight for a case where manned driving is performed by the onboard person. The predetermined range to which the line of sight of the onboard person is guided is set in advance, for example.

For example, after normally acquiring the strength of an impression utterance, the topic strength estimation unit 137 may add a predetermined value to the topic strength of an impression utterance that takes, as a topic, an object that is present in the predetermined range in the captured image from the outside-view camera 202, and may thereby increase the topic strength of such an impression utterance. An object that causes the topic strength to be set higher may be a vehicle that is traveling in front of the vehicle 2, or a vehicle or a building that is present in a forward direction of the vehicle 2 and that has a characteristic appearance, for example.

Furthermore, in the case where transition to the line-of-sight guidance mode takes place, the utterance determination unit 14 prioritizes the impression utterance over the context utterance even when there is an utterance from the onboard person, and selects the impression utterance as the system utterance. At this time, because the topic strength of the impression utterance that takes, as a topic, an object that is present in the predetermined range that is in the captured image from the outside-view camera 202 and to which the line of sight is desired to be guided is set to be higher by the topic strength estimation unit 137, the impression utterance is selected as the system utterance. Additionally, the functional configuration of the server 1 is not limited to the configuration illustrated in FIG. 3.

### Flow of Processes

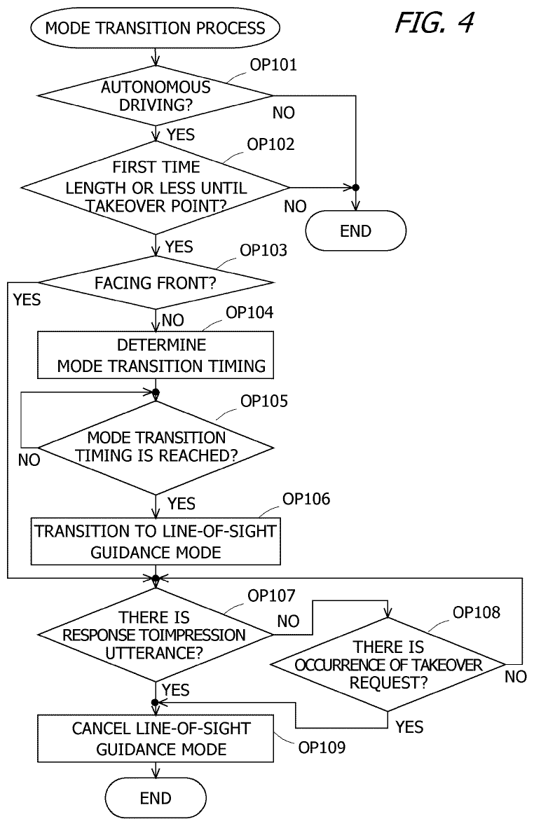

FIG. 4 is an example of a flowchart of a mode transition process by the line-of-sight guidance control unit 16. The process illustrated in FIG. 4 is repeated every predetermined period of time. An execution period of the process illustrated in FIG. 4 is freely set from 0.01 seconds to one second, for example. A main performer of the process illustrated in FIG. 4 is the CPU 101 of the server 1. However, in FIG. 4, a functional structural element is described to be the performer for the sake of convenience. The same applies to flowcharts of processes by the server 1 described below.

In OP101, the line-of-sight guidance control unit 16 determines whether autonomous driving or manned driving is being performed in relation to the vehicle 2, based on latest information about the travel state of the vehicle 2. In the case where autonomous driving of the vehicle 2 is being performed (OP101: YES), the process proceeds to OP102. In the case where manned driving of the vehicle 2 is being performed (OP101: NO), the process illustrated in FIG. 4 is ended.

In OP102, the line-of-sight guidance control unit 16 determines whether it is the first time length or less until the takeover point. The first time length may be freely set by the administrator of the conversational system 100 within a range from 30 seconds to three minutes, for example. When it is the first time length or less until the takeover point (OP102: YES), the process proceeds to OP103. In the case where it is longer than the first time length until the takeover point (OP102: NO), the process illustrated in FIG. 4 is ended.

In OP103, the line-of-sight guidance control unit 16 determines whether the onboard person is facing front or not, based on the latest captured image from the inside-view camera 207. In the case where the onboard person is facing front (OP103: YES), the process proceeds to OP107. In the case where the onboard person is not facing front (OP103: NO), the process proceeds to OP104. In OP104, the line-of-sight guidance control unit 16 determines the mode transition timing. The mode transition timing is determined to be in a period when the remaining time until arrival at the takeover point is five seconds to one minute, for example. Accordingly, the mode transition timing precedes occurrence of the takeover request.

In OP105, the line-of-sight guidance control unit 16 determines whether the mode transition timing is reached or not. In the case where the mode transition timing is reached (OP105: YES), the process proceeds to OP106. Until the mode transition timing is reached (OP105: NO), the line-of-sight guidance control unit 16 stays in a standby state.

In OP106, the line-of-sight guidance control unit 16 notifies the impression utterance system 13 and the utterance determination unit 14 of transition to the line-of-sight guidance mode. In OP107, the line-of-sight guidance control unit 16 determines whether utterance content of the onboard person as a response to the impression utterance is received or not. In the case where there is a response to the impression utterance (OP107: YES), the process proceeds to OP109. In the case where there is no response to the impression utterance (OP107: NO), the process proceeds to OP108.

In OP108, the line-of-sight guidance control unit 16 determines whether there is occurrence of the takeover request in the vehicle 2 or not. An estimation result may be used to indicate whether there is occurrence of the takeover request in the vehicle 2 or not. In the case where there is occurrence of the takeover request in the vehicle 2 (OP108: YES), the process proceeds to OP109. In the case where there is no occurrence of the takeover request in the vehicle 2 (OP108: NO), the process proceeds to OP107. Additionally, even in a case where the takeover request is not actually generated in the vehicle 2 for some reason, positive determination is made in OP108 when the timing of occurrence of the takeover request estimated by the line-of-sight guidance control unit 16 is reached. Alternatively, positive determination is made in OP108 in a case where information indicating that manned driving is being performed is included in the information about the travel state of the vehicle 2 received from the vehicle 2.

In OP109, the line-of-sight guidance control unit 16 notifies the impression utterance system 13 and the utterance determination unit 14 of cancelation of the line-of-sight guidance mode. Then, the process illustrated in FIG. 4 is ended.

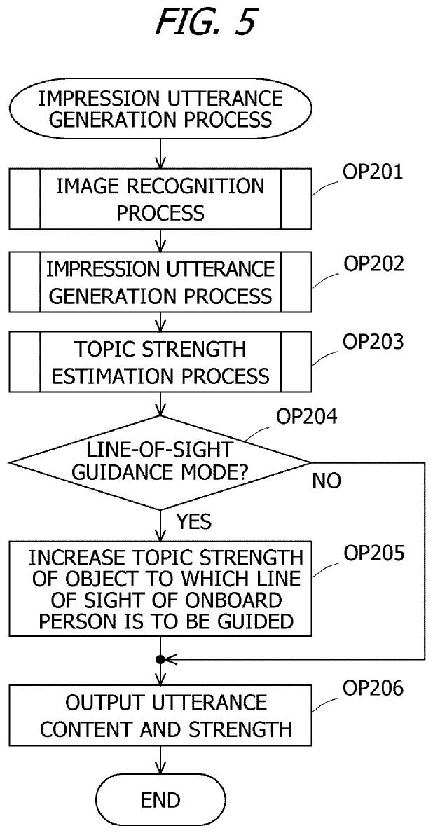

FIG. 5 is an example of a flowchart of an impression utterance generation process by the impression utterance system 13. The process illustrated in FIG. 5 is repeated every predetermined period of time, for example. An execution period of the process illustrated in FIG. 5 is freely set from one second to 10 seconds by the administrator of the conversational system 100 or the onboard person of the vehicle 2, for example. The process illustrated in FIG. 5 is performed on a latest captured image that is stored in the image history DB 131 at a timing of start. In the description of FIG. 5, a captured image refers to the latest captured image that is stored in the image history DB 131 at the timing of start.

In OP201, the image feature extraction unit 134 performs the image recognition process on the captured image, and detects an object from the captured image. In OP202, the impression utterance generation unit 136 generates the impression utterance in relation to the object detected from the captured image. In OP203, the topic strength estimation unit 137 estimates strength of the topic in relation to the impression utterance generated by the impression utterance generation unit 136.

In OP204, the topic strength estimation unit 137 determines whether it is the line-of-sight guidance mode or not. In the case where it is the line-of-sight guidance mode (OP204: YES), the process proceeds to OP205. In the case where it is not the line-of-sight guidance mode (OP204: NO), the process proceeds to OP206.

In OP205, of the impression utterances, the topic strength estimation unit 137 sets the topic strength of an impression utterance that takes, as a topic, an object that is present in the predetermined range that is in the captured image from the outside-view camera 202 and to which the line of sight of the onboard person is guided to be higher than that of other impression utterances.

In OP206, the impression utterance and estimated strength of the impression utterance are output to the utterance determination unit 14 respectively from the impression utterance generation unit 136 and the topic strength estimation unit 137. Then, the process illustrated in FIG. 5 is ended.

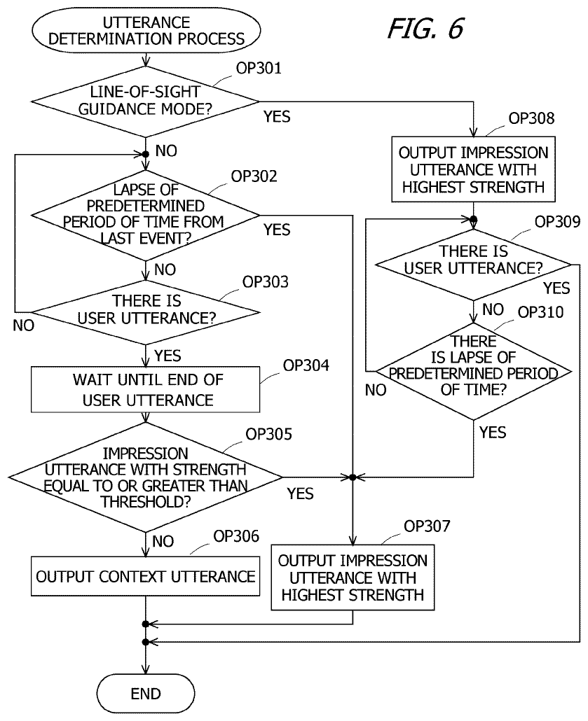

FIG. 6 is an example of a flowchart of an utterance determination process by the utterance determination unit 14. The process illustrated in FIG. 6 is repeated every predetermined period of time.

In OP301, the utterance determination unit 14 determines whether it is the line-of-sight guidance mode or not. In the case where it is the line-of-sight guidance mode (OP301: YES), the process proceeds to OP308. In the case where it is not the line-of-sight guidance mode (OP301: NO), the process proceeds to OP302.

In OP302, the utterance determination unit 14 determines whether there is a lapse of a predetermined period of time from an immediately preceding event. An immediately preceding event may be an immediately preceding system utterance, an utterance of the onboard person, or start of a conversation with the onboard person in the vehicle 2, for example. A time length that is used in the determination in OP302 as a threshold related to an elapsed time from an immediately preceding event is five seconds to 10 seconds, for example. In the case where there is a lapse of the predetermined period of time from the immediately preceding event (OP302: YES), the process proceeds to OP307. In the case where there is no lapse of the predetermined period of time from the immediately preceding event (OP302: NO), the process proceeds to OP303.

In OP303, the utterance determination unit 14 determines whether there is a user utterance or not. A user utterance is utterance content from the onboard person in the vehicle 2. Whether there is a user utterance or not is determined based on whether there is input of context utterance from the context utterance generation unit 12 or not, for example. In the case where there is a user utterance (OP303: YES), the process proceeds to OP304. In OP304, the utterance determination unit 14 stays in standby until end of the user utterance. In the case where there is no user utterance (OP303: NO), the process proceeds to OP302.

In OP305, the utterance determination unit 14 determines whether there is an impression utterance having strength that is equal to or greater than a threshold, among impression utterances generated within an immediately preceding predetermined period of time. Additionally, the threshold is set according to a range of values of the topic strength. For example, the threshold is set to a value that is about 80% of a maximum value of the topic strength. The immediately preceding predetermined period of time is a time from an immediately preceding event to a current time point, for example. In the case where there is an impression utterance having strength that is equal to or greater than the threshold (OP305: YES), the process proceeds to OP307. In the case where there is no impression utterance having strength that is equal to or greater than the threshold (OP305: NO), the process proceeds to OP306.

In OP306, the utterance determination unit 14 transmits the context utterance as the system utterance, to the vehicle 2 through the transmission unit 15. Then, the process illustrated in FIG. 6 is ended. In OP307, the utterance determination unit 14 transmits the impression utterance with the highest topic strength as the system utterance, to the vehicle 2 through the transmission unit 15. Then, the process illustrated in FIG. 6 is ended.

In the case where it is the line-of-sight guidance mode (OP301: YES), the process in OP308 is performed. In OP308, the utterance determination unit 14 transmits the impression utterance with the highest strength as the system utterance, to the vehicle 2 through the transmission unit 15, regardless of whether there is a context utterance or not. The impression utterance that is the target of OP308 is the impression utterance that is generated after the immediately preceding event, for example.

In OP309, the utterance determination unit 14 determines whether there is a user utterance in relation to the system utterance output in OP308. In the case where there is a user utterance (OP309: YES), the process illustrated in FIG. 6 is ended. In this case, the line-of-sight guidance mode is canceled (OP107, OP108 in FIG. 4).

In the case where there is no user utterance (OP309: NO), the process proceeds to OP310. In OP310, the utterance determination unit 14 determines whether or not there is a lapse of a predetermined period of time from the system utterance in OP308. A time length used in OP310 as a threshold related to the elapsed time from the system utterance in OP308 is from one second to five seconds, for example. The system utterance is repeatedly performed in the line-of-sight guidance mode until there is an utterance from the onboard person, and thus, the time length as the threshold is set to be relatively short. In the case where there is a lapse of the predetermined period of time (OP310: YES), the process proceeds to OP307, and the impression utterance with the highest topic strength is transmitted again to the vehicle 2 as the system utterance. In this manner, even in a case where the onboard person is asleep, for example, the system utterance is repeatedly performed until the onboard person wakes up. In the case where there is no lapse of the predetermined period of time (OP310: NO), the process proceeds to OP309.

### Operations and Effects of First Embodiment

In the first embodiment, the impression utterance that takes, as the topic, an object that is detected from the captured image from the outside-view camera 202 is transmitted from the server 1 to the vehicle 2 at a timing preceding the takeover request. Accordingly, the onboard person of the vehicle 2 is made to spontaneously pay attention to the front area of the vehicle 2 at the timing preceding occurrence of the takeover request.

Then, when the takeover request is generated, the onboard person is already paying attention to the front area of the vehicle, and is able to easily cope with the takeover.

### Other Embodiments

The embodiments described above are examples, and the present disclosure may be changed and carried out as appropriate without departing from the gist of the present disclosure.

Functional components same as those of the server 1 may be mounted in the vehicle-mounted apparatus 201 of the vehicle 2 to allow the vehicle-mounted apparatus 201 to perform the processes of the server 1 according to the first embodiment. That is, the vehicle-mounted apparatus 201 may perform utterance generation. Alternatively, functional components same as those of the server 1 may be provided in a user terminal such as a smartphone, and the user terminal may perform same processes as the server 1 according to the first embodiment by performing conversation with the onboard person. In this case, the user terminal may use a microphone and a speaker of the user terminal to acquire voice of the onboard person and to output the system utterance in the form of sound from the speaker.

The processes and means described in the present disclosure may be freely combined to the extent that no technical conflict exists.

A process which is described to be performed by one device may be performed among a plurality of devices. Processes described to be performed by different devices may be performed by one device. Each function to be implemented by a hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a processor configured to:
determine a first timing that precedes a notification for announcing in advance switching from autonomous driving of a moving object to manned driving, in a case where occurrence of the switching is predicted due to the moving object capable of autonomous driving approaching a predetermined location, and
output to the moving object, in a case where the first timing is reached, utterance content that takes, as a topic, an object that is present in front of the moving object, the object being detected from a captured image from an on-board camera of the moving object.

2. The information processing apparatus according to claim 1, wherein the processor is further configured to:
generate first utterance content that results from an utterance from an onboard person in the moving object,
generate second utterance content that takes, as a topic, an object detected from the captured image from the on-board camera, and
determine utterance content to be output, from the first utterance content and the second utterance content, wherein
in the case where the first timing is reached, the second utterance content is prioritized over the first utterance content, and the second utterance content that takes, as the topic, the object that is present in front of the moving object is determined to be the utterance content to be output.

3. The information processing apparatus according to claim 1, wherein the processor is further configured to:
set a degree of priority to each of at least one utterance content that takes, as a topic, a respective one of at least one object detected from the captured image from the on-board camera, and
determine the utterance content to be output, based on the degree of priority, wherein
in the case where the first timing is reached, the degree of priority is set higher for the utterance content that takes, as the topic, an object that is present in a predetermined range in front of the moving object.

4. The information processing apparatus according to claim 1, wherein the processor determines the first timing based on at least one of a state of an onboard person in the moving object, a type of a road where the moving object is traveling, and a type of a location that is a cause of occurrence of the switching.

5. A method executed by a computer, comprising:
determining a first timing that precedes a notification for announcing in advance switching from autonomous driving of a moving object to manned driving, in a case where occurrence of the switching is predicted due to the moving object capable of autonomous driving approaching a predetermined location, and
outputting to the moving object, in a case where the first timing is reached, utterance content that takes, as a topic, an object that is present in front of the moving object, the object being detected from a captured image from an on-board camera of the moving object.
